(19) United States
(12) Patent Application Publication
(10) Pub. No.: US 2013/0227409 A1
(43) Pub. Date: Aug. 29, 2013

(54) INTEGRATING SENSATION FUNCTIONALITIES INTO SOCIAL NETWORKING SERVICES AND APPLICATIONS

(71) Applicants: Saumitra Mohan DAS, San Jose, CA (US); Vinay Sridhara, Santa Clara, CA (US); Leonid Sheynblat, Hillsborough, CA (US)

(72) Inventors: Saumitra Mohan DAS, San Jose, CA (US); Vinay Sridhara, Santa Clara, CA (US); Leonid Sheynblat, Hillsborough, CA (US)

(73) Assignee: QUALCOMM Incorporated, San Diego, CA (US)

(21) Appl. No.: 13/594,434

(22) Filed: Aug. 24, 2012

Related U.S. Application Data
(60) Provisional application No. 61/568,071, filed on Dec. 7, 2011.

(51) Int. Cl. H04L 29/06

(52) U.S. Cl. CPC H04L 65/403
USPC 715/702

(57) ABSTRACT

Methods, apparatuses, systems, and computer-readable media for integrating sensation functionalities into social networking services and/or applications are presented. According to one or more aspects, a computing device may receive a status update associated with a social networking service, and the status update may include haptic data. Subsequently, the computing device may cause haptic feedback to be provided to at least one user of the social networking service, based at least in part on the haptic data and the at least one user's relationship with a sender of the status update within the social networking service. In at least one arrangement, first haptic feedback is provided to the user if the user is within a first group of users, and second haptic feedback different from the first haptic feedback is provided to the user if the user is within a second group of users different from the first group of users.

### CLAIM OF PRIORITY UNDER 35 U.S.C. §119

This application claims priority to U.S. Provisional Patent Application Ser. No. 61/568,071, filed Dec. 7, 2011, and entitled “Integrating Sensation Functionalities into Social Networking Services and Applications,” which is incorporated by reference herein in its entirety for all purposes.

### BACKGROUND

Aspects of the disclosure relate to computing technologies. In particular, aspects of the disclosure relate to mobile computing device technologies, such as systems, methods, apparatuses, and computer-readable media for integrating sensation functionalities into social networking services and/or applications.

Currently, some computing devices, such as cellular phones, smart phones, personal digital assistants (PDAs), tablet computers, and other mobile devices, may provide simple haptic feedback (e.g., tactile and/or touch-based feedback) in limited circumstances. For example, a cellular phone or smart phone may briefly vibrate to notify a user that a new message or update has been received via a social networking service. However, this might be the full extent to which such a current device can provide haptic feedback. By implementing one or more aspects of the disclosure, enhanced functionality, greater convenience, and improved flexibility may be achieved, for instance, in providing haptic feedback to users of these and other computing devices in connection with social networking services and applications.

### SUMMARY

Systems, methods, apparatuses, and computer-readable media for integrating sensation functionalities into social networking services and applications are presented. According to one or more aspects, “sensation functionalities” may be integrated into social networking services and applications by embedding and/or otherwise associating haptic data with status updates created in and/or provided via a social networking service, where such haptic data may cause haptic feedback to be provided to a recipient of the status update. As used herein, haptic feedback may include any kind of tactile and/or touch-based feedback, such as various texture sensations, pressure sensations, wetness sensations, adhesion sensations, thermal sensations, vibratory sensations, and/or any other effects that may be sensed by a person using his or her sense of touch. An electronic device, such a smart phone, personal digital assistant, tablet computer, and/or any other kind of mobile computing device, may provide such haptic feedback using one or more electronically actuated mechanical, electrical, and/or electromechanical components. In one example, for instance, piezoelectric transducers may be used to simulate pinching, protrusions, punctures, textures, and/or other tactile sensations.

Some current devices may provide simple haptic feedback in connection with social networking services in limited circumstances (e.g., briefly vibrating to notify a user that a new message or update has been received via a social networking service). However, the functionalities included in current devices are limited in both the types of haptic feedback that may be provided to a user and also in the extent to which users may customize the haptic feedback to be provided. By implementing one or more aspects of the disclosure, haptic data may be encoded in status updates associated with a social networking service, and various sensations may be provided as haptic feedback to users who view such status updates. Advantageously, these and other features described herein may provide enhanced flexibility, convenience, and functionality in social networking applications and/or devices.

According to one or more aspects of the disclosure, a computing device may receive a status update associated with a social networking service, and the status update may include haptic data. Subsequently, the computing device may cause haptic feedback to be provided, based at least in part on the haptic data and a relationship between at least one user account of the social networking service provided via the computing device and a sender of the status update within the social networking service.

In one or more arrangements, the haptic data may identify at least one haptic sensation to be provided to a recipient of the status update. Additionally or alternatively, the haptic data may be specified by the sender of the status update.

In still one or more arrangements, first haptic feedback may be provided if the at least one user account is within a first group of users, and second haptic feedback different from the first haptic feedback may be provided if the at least one user account is within a second group of users different from the first group of users. In at least one arrangement, the first group of users and the second group of users may be defined by a sender of the status update.

In still one or more arrangements, the haptic data may be embedded in a header of a webpage that includes the status update. In one or more additional or alternative arrangements, the haptic feedback may correspond to an implied message. In some arrangements, the implied message may correspond to a feature provided by the social networking service, while in other arrangements, the haptic feedback may correspond to a poke feature provided by the social networking service.

In at least one arrangement, receiving the status update associated with the social networking service may include receiving first information specifying first haptic feedback to be provided to a first group of recipients of the status update, and may further include receiving second information specifying second haptic feedback to be provided to a second group of recipients of the status update, where the second group of recipients of the status update is different from the first group of recipients of the status update. Additionally or alternatively, causing the haptic feedback to be provided may include determining whether the at least one user account is in the first group of recipients of the status update or the second group of recipients of the status update. In response to determining that the at least one user account is in the first group of recipients of the status update, the first haptic feedback may be caused to be provided. On the other hand, in response to determining that the at least one user account is in the second group of recipients of the status update, the second haptic feedback may be caused to be provided, where the second haptic feedback may be different from the first haptic feedback.

### BRIEF DESCRIPTION OF THE DRAWINGS

Aspects of the disclosure are illustrated by way of example. In the accompanying figures, like reference numbers indicate similar elements, and:

FIGS. 1A and 1B illustrate an example device that may implement one or more aspects of the disclosure.

FIG. 2 illustrates an example method of integrating sensation functionalities into social networking services and/or applications according to one or more illustrative aspects of the disclosure.

FIG. 3 illustrates an example method of processing status updates that include sensation information according to one or more illustrative aspects of the disclosure.

FIGS. 4A and 4B illustrate examples of haptic feedback that may be provided by a device according to one or more illustrative aspects of the disclosure.

FIGS. 5-8 illustrate example user interfaces for composing status updates that include sensation information according to one or more illustrative aspects of the disclosure.

FIGS. 9-11 illustrate example user interfaces for displaying status updates that include sensation information according to one or more illustrative aspects of the disclosure.

FIG. 12 illustrates an example method of composing a status update that includes sensation information according to one or more illustrative aspects of the disclosure.

FIG. 13 illustrates an example method of displaying a status update that includes sensation information according to one or more illustrative aspects of the disclosure.

FIG. 14 illustrates an example computing system in which one or more aspects of the disclosure may be implemented.

### DETAILED DESCRIPTION

Several illustrative embodiments will now be described with respect to the accompanying drawings, which form a part hereof While particular embodiments, in which one or more aspects of the disclosure may be implemented, are described below, other embodiments may be used and various modifications may be made without departing from the scope of the disclosure or the spirit of the appended claims.

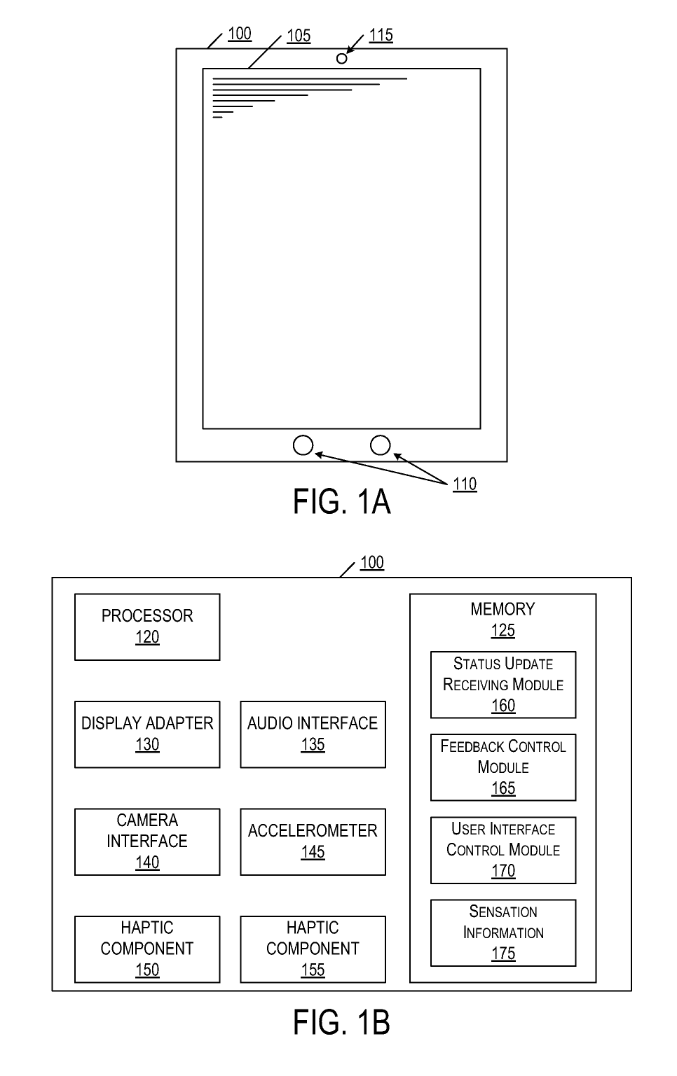

FIGS. 1A and 1B illustrate an example device that may implement one or more aspects of the disclosure. As seen in FIG. 1A, for example, computing device 100 may include one or more components, such as a display 105, buttons and/or keys 110, and/or a camera 115. In one or more arrangements, display 105 may be a touch screen, such that a user may be able to provide touch-based user input to computing device 100 via display 105. In addition, a user may be able to provide tactile user input to computing device 100 by touching, interacting with, engaging, and/or otherwise stimulating one or more haptic sensors included in (and/or otherwise communicatively coupled to) computing device 100, such as those illustrated in FIG. 1B.

As seen in FIG. 1B, for example, computing device 100 may include a plurality of internal components. For example, computing device 100 may include one or more processors (e.g., processor 120), one or more memory units (e.g., memory 125), at least one display adapter (e.g., display adapter 130), at least one audio interface (e.g., audio interface 135), one or more camera interfaces (e.g., camera interface 140), one or more motion sensors (e.g., one or more accelerometers, such as accelerometer 145, one or more gyroscopes, one or more magnetometers, etc.), and/or other components.

In addition, computing device 100 may further include one or more haptic components, such as haptic component 150 and haptic component 155. According to one or more aspects, each of haptic component 150 and haptic component 155 may be and/or include one or more piezoelectric transducers, and/or one or more other components capable of and/or configured to produce various forms of haptic feedback.

In some arrangements, the one or more haptic components included in computing device 100 (e.g., haptic component 150, haptic component 155, etc.) may be the same type of component and/or may produce the same form of haptic feedback (e.g., texture sensations, wetness sensations, thermal sensations, etc.), while in other arrangements, the one or more haptic components included in computing device 100 may be different types of components and/or or may produce different forms of haptic feedback. Additionally or alternatively, the one or more haptic components included in computing device 100 may operate individually and/or in combination to produce a plurality of different tactile effects. Although these haptic components (e.g., haptic component 150, haptic component 155, etc.) are described as being “included in” computing device 100, it should be understood that these haptic components might not necessarily be inside of computing device 100. For example, it is contemplated that in some arrangements, one or more of these haptic components may be disposed along exterior surfaces of computing device 100. Additionally or alternatively, any and/or all of these haptic components may be incorporated into and/or provided as part of one or more peripheral accessories, which, for instance, may be communicatively coupled to computing device 100 (e.g., via one or more wireless and/or wired connections).

In some embodiments, memory 125 may store one or more program modules, as well as various types of information, that may be used by processor 120 and/or other components of device 100 in providing the various features and functionalities discussed herein. For example, memory 125 may, in some embodiments, include a status update receiving module 160, which may enable device 100 to receive a status update associated with a social networking service (e.g., by authenticating with the social networking service to login to a particular user account, downloading new status updates and/or other messages associated with the user account, etc.). In some instances, the status update received by status update receiving module 160 may include haptic data that identifies one or more haptic sensations to be provided to a recipient of the status update (e.g., to a user of device 100).

In some embodiments, memory 125 may further include a feedback control module 165. Feedback control module 165 may, for instance, enable device 100 to cause haptic feedback to be provided based on the haptic data included in the status update received by status update receiving module 160. For example, feedback control module 165 may cause haptic components 150 and 155 to provide haptic feedback to a user of device 100. As another example, feedback control module 165 may, in some instances, enable device 100 to cause different haptic feedback to be provided depending on the relationship of the user of device 100 and/or the user's account with the sender of the status update, as such a relationship may be defined on the social networking service.

In some embodiments, memory 125 may further include a user interface control module 170. User interface control module 170 may, for instance, enable device 100 to display one or more user interfaces, such as the various user interfaces described in greater detail below. In one example, user interface control module 170 also may enable device 100 to display an indicator (e.g., using display adapter 130), and in some instances, the indicator may be configured to notify a user of device 100 that haptic feedback is available (e.g., with respect to particular content being displayed on device 100, such as the status update received by status update receiving module 160). In addition, user interface control module 170 may be configured to receive and/or process user input (e.g., received from a user of device 100). This may, for example, enable haptic feedback to be provided by device 100 in response to a user selection of an indicator provided by user interface control module 170.

In some embodiments, memory 125 also may store sensation information 175. Sensation information 175 may, for instance, include information that defines one or more predefined haptic feedback sensations, one or more user-defined haptic feedback sensations, and/or one or more other haptic feedback sensations. For example, sensation information 175 may include various haptic data, such as the haptic data discussed in greater detail below, and this haptic data may be used by device 100 in providing haptic feedback.

While the program modules discussed above are described as being included in memory 125, in some additional and/or alternative embodiments, these modules (e.g., status update receiving module 160, feedback control module 165, and/or user interface control module 170) can be provided by processor 120, by one or more separate and/or individual processors, and/or by other hardware components instead of and/or in addition to those discussed above. For example, in some embodiments, status update receiving module 160 may be provided as and/or by a first processor, feedback control module 165 may be provided as and/or by a second processor, and user interface control module 170 may be provided as and/or by a third processor.

Having described an example of a computing device 100 in which various aspects of the disclosure may be implemented, for instance, in integrating sensation functionalities into social networking services and/or applications, several example methods that may be performed and/or otherwise implemented to integrate sensation functionalities into social networking services and/or applications and/or process status updates that include sensation information will now be described.

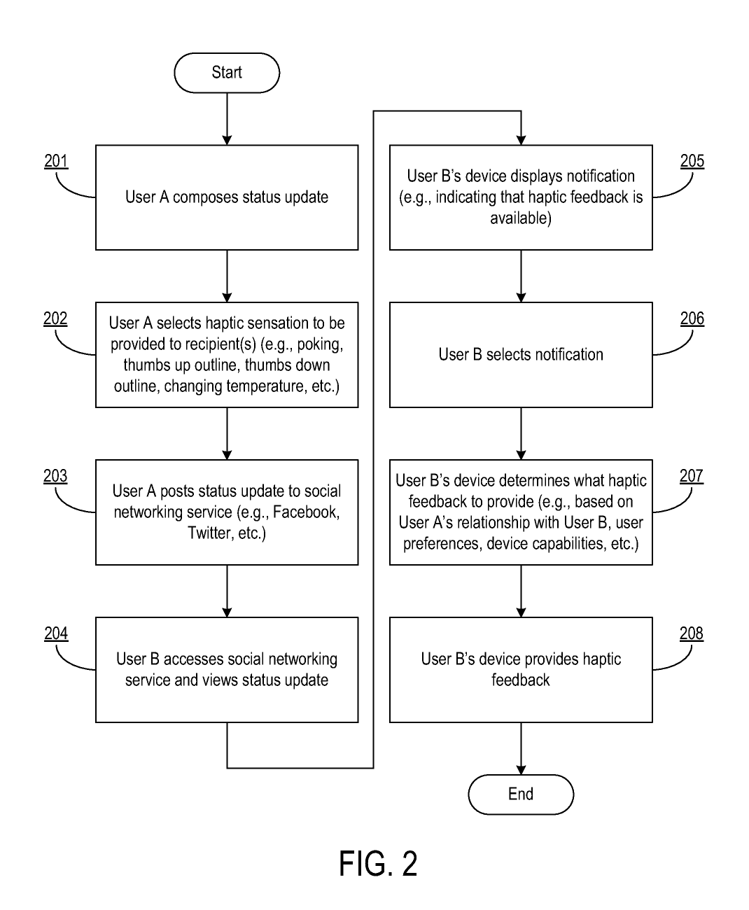

FIG. 2 illustrates an example method of integrating sensation functionalities into social networking services and/or applications according to one or more illustrative aspects of the disclosure. In step 201 of the example method, a first user (e.g., “User A”) may compose a status update. As used herein, a “status update” may include any sort of message, posting, and/or other content item created by a user using and/or to be used with a social networking service. Examples of status updates include Facebook messages and wall posts, Twitter tweets, Google Plus updates, and so on.

Subsequently, in step 202, the first user may select a haptic sensation to be provided to one or more recipients of the status update (e.g., other users of the social networking service who may view the status update via the social networking service). The selected haptic sensation may include one or more types of haptic feedback sensations (e.g., texture sensations, pressure sensations, etc.). In one embodiment, the first user's computing device may display a menu in which various haptic feedback sensations are listed (e.g., a poke, a thumbs up outline, a thumbs down outline, a change in temperature, etc.), and the first user may select a haptic sensation to be provided to one or more recipients of the status update by selecting one or more options from the menu. In another embodiment, the first user's computing device may display a user interface in which the first user may draw (e.g., by providing touch-based user input to a touch screen included in the computing device) an outline of a shape to be provided as haptic feedback to one or more recipients of the status update.

In at least one arrangement, the haptic feedback selected in step 202 may comprise an “implied message,” which may be a tactile action that holds a particular meaning when used with a social networking service. Examples of implied messages may include a poking action, which may correspond to a Facebook “poke” feature, a thumbs up outlining action, which may correspond to a Facebook “like” feature, and so on. Other forms of haptic feedback may likewise embody other implied messages associated with other features of one or more social networking services.

In step 203 of the example method, the first user may post the status update to a social networking service (e.g., Facebook, Twitter, etc.). For example, the first user's computing device may transmit information corresponding to the status update and the selected haptic sensation to one or more servers operated by the social networking service.

In step 204, a second user (e.g., “User B”) may access the social networking service and view the status update. For example, a second user's computing device may download and display a webpage provided by the social networking service that includes the status update created by the first user. In at least one arrangement, haptic data associated with the status update (e.g., haptic data identifying the haptic sensation selected by the first user) may be embedded as meta data in the web page and/or be included in a header of the webpage.

In step 205, the second user's computing device may display a notification that may, for instance, indicate that haptic feedback is available. The notification may include an icon indicating that the status update includes embedded haptic data that can be downloaded and/or played back as a sensation to the second user.

In step 206, the second user may select the displayed notification. The second user's computing device may receive the selection as user input and may interpret the selection as a request to play back the haptic sensation identified by the haptic data embedded in the status update.

In step 207, the second user's computing device may determine what haptic feedback to provide. In one or more embodiments, determining what haptic feedback to provide may be based on the first user's relationship with the second user within the social networking service. For instance, the first user may have sorted contacts in the social networking service into various groups, such as a “friends” group, a “family” group, and a “co-workers” group. Depending upon which group the second user is included, the second user may be provided with different haptic feedback.

For example, the first user may post a single status update and may wish to share, via the status update, a haptic sensation in the form of a “heart” outline with members of the “family” group, but the first user may wish for members of the “co-workers” group to be provided with a haptic sensation in the form of a “smiley face” outline when viewing the same status update. The second user's computing device, in determining what haptic feedback to provide, may identify a group to which the second user belongs, and subsequently may determine, based on the haptic data embedded in the status update and based on the identified group, what haptic feedback should be provided to the second user. In one or more alternative arrangements, this determination may be performed in combination with and/or solely by a server computer of the social networking service.

Thereafter, in step 208, the second user's computing device may provide haptic feedback to the second user. As described above, this haptic feedback may be provided to the second user by electronically actuating one or more transducers and/or other components in order to create the desired effect or effects.

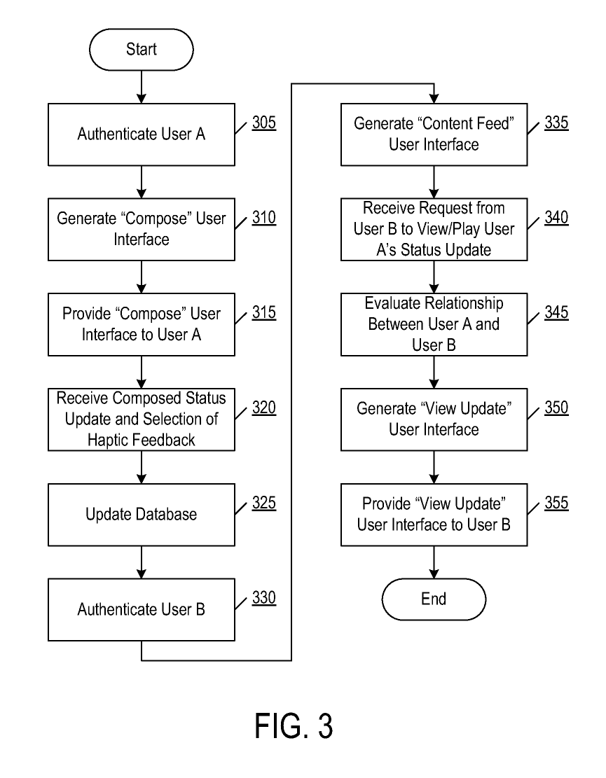

FIG. 3 illustrates an example method of processing status updates that include sensation information according to one or more illustrative aspects of the disclosure. According to one or more aspects, any and/or all of the methods and/or method steps described herein may be performed by a computing device, such as computing device 100 or the computing device 1400, which is described in greater detail below, and/or may be implemented as computer-executable instructions, such as computer-executable instructions stored in a memory of an apparatus and/or computer-executable instructions stored in a computer-readable medium.

In step 305, a first user (e.g., “User A”) may be authenticated. For example, in step 305, a social networking server computer (which may embody one or more aspects of, e.g., computing device 100, computer system 1400 described below, etc.) may authenticate a first user. Such authentication may include generating, transmitting, and/or displaying a login page to a first user, receiving user input corresponding to a user identifier and/or a password, and validating the received user input, for instance, by checking the provided user identifier and/or password against information stored in a user account database.

Subsequently, in step 310, a compose user interface may be generated. For example, in step 310, the social networking server computer may generate a user interface (e.g., a web page) that includes one or more controls and/or other elements that allow and/or are configured to allow a user to compose a status update to be sent via and/or posted to a social networking service, such as the social networking service operating, provided by, and/or otherwise associated with the social networking server computer.

In step 315, the compose user interface may be provided to the first user. For example, in step 315, the social networking server computer may transmit (e.g., via a TCP/IP data connection) the user interface generated in step 310 to a computing device being used by the first user (e.g., computing device 100), such that the first user's computing device may receive the user interface and display the user interface to the first user.

In step 320, a composed status update and a selection of haptic feedback may be received. For example, in step 320, the social networking server computer may receive (e.g., via the TCP/IP data connection) data, from the first user's computing device, for instance, that includes a status update composed and/or otherwise created by the first user, as well as a selection of one or more haptic sensations that are to be embedded into, provided with, and/or otherwise associated with the status update. In at least one arrangement, additional data associated with the status update also may be received from the first user's computing device, where the additional data may indicate which other users and/or groups of users of the social networking service should be able to view the status update, what haptic sensation(s), if any, are to be provided to various users and/or groups of users in connection with the status update, and/or the like.

In one or more arrangements, the one or more haptic sensations that are to be embedded into, provided with, and/or otherwise associated with the status update may include at least one non-vibratory haptic sensation. As used herein, a “non-vibratory” haptic sensation may include any sensation that includes at least one effect that does not involve producing vibration. Examples of non-vibratory sensations include texture sensations, pressure sensations, wetness sensations, adhesion sensations, and thermal sensations, produced either alone, in combination with each other, or in combination with one or more vibratory sensations. For example, a texture sensation or a protrusion effect produced either alone or in combination (e.g., with each other) could be considered non-vibratory haptic sensations. As another example, a protrusion effect and a vibration sensation produced in combination (e.g., with each other) could be considered a non-vibratory haptic sensation, whereas the vibration sensation produced on its own might not be considered a non-vibratory haptic sensation.

In step 325, a database may be updated. For example, in step 325, the social networking server computer may update a database in which status updates and/or other information associated with the social networking service is stored to store and/or otherwise include information corresponding to the status update composed by the first user and/or the one or more haptic sensations associated with the status update. For instance, the social networking server computer may store the information received from the first user's computing device into a content database stored on and/or otherwise accessible to the social networking server computer.

In step 330, a second user (e.g., “User B”) may be authenticated. For example, in step 330, the social networking server computer may authenticate a second user (e.g., a second user of the social networking service and/or application, who may, for instance, be different from the first user). Such authentication may include generating, transmitting, and/or displaying a login page to the second user, receiving user input corresponding to a user identifier and/or a password, and validating the received user input, for instance, by checking the provided user identifier and/or password against information stored in a user account database.

In step 335, a content feed user interface may be generated. For example, in step 335, the social networking server computer may generate a user interface (e.g., a web page) that includes one or more controls and/or other elements in which one or more content items associated with the social networking service and/or application may be displayed. Such content items may include, for instance, status updates and/or other content created by other users of the social networking service and/or posted online to and/or via the social networking service. In one example, the content feed user interface may include a Facebook “News Feed” user interface that includes a plurality of Facebook status updates, a Twitter user interface that includes a stream of Twitter updates, and/or a Google Plus user interface that includes a listing of Google Plus updates. In addition, the social networking server computer may provide the user interface to the second user (e.g., by transmitting and/or otherwise sending, for instance, via a TCP/IP data connection, the user interface to the second user's computing device, which may embody one or more aspects of computing device 100).

In step 340, a request to view and/or play the status update composed by the first user may be received from the second user. For example, in step 340, the social networking server computer may receive a request (e.g., from the second user and/or the second user's computing device) to view the status update composed by the first user (and received, for instance, from the first user in step 320, above) and/or play back the haptic sensation(s) associated therewith. In at least one arrangement, such a request may be received as an HTTP GET command corresponding to a request, by the second user's computing device, for a URL corresponding to the first user's previously created and stored status update.

In step 345, the relationship between the first user and the second user may be evaluated. For example, in step 345, the social networking server computer may evaluate and/or otherwise analyze the relationship between the first user and the second user to determine whether the second user has privileges to view the status update, whether the second user has privileges to receive one or more haptic sensations associated with the status update, and/or what haptic sensation(s), if any, should be provided to the second user.

In at least one arrangement, evaluating the relationship between the first user and the second user may include determining whether the second user is included in one or more groups defined by the first user, where, for instance, such groups are defined on and/or otherwise in connection with the social networking service. For example, the first user may have defined a first group of users (e.g., a “Family” group that includes users of the social networking service who are members of the first user's family), a second group of users (e.g., a “Friends” group that includes users of the social networking service who are friends of the first user), and a third group of users (e.g., a “Co-workers” group that includes users of the social networking service who are co-workers of the first user). Additionally or alternatively, the first user may have defined these groups on and/or otherwise in connection with the social networking service by creating the one or more groups, via one or more user interfaces provided by the social networking service (e.g., provided via the social networking server computer to the first user's computing device), and/or by subsequently editing the one or more groups, via the one or more user interfaces provided by the social networking service, to include the users of the social networking service desired by the first user. Any and/or all of this information may be stored in a database by the social networking server computer, and thus the social networking server computer may evaluate the relationship between the first user and the second user based on any and/or all of this stored information.

Subsequently, in step 350, a view update user interface may be generated. For example, in step 350, the social networking server computer may generate a user interface (e.g., a web page) that includes the status update (e.g., if it is determined, in step 345, that the second user has sufficient privileges to access and/or view the status update). Additionally or alternatively, in generating this user interface, the social networking server may embed haptic data into the user interface (e.g., as embedded metadata in the HTML code and/or other computer code that forms all or part of the web page on which the status update may be displayed), where such haptic data may identify the haptic sensation(s) to be provided to the second user and/or may correspond to the first user's selection regarding haptic sensation(s) to be associated with the status update.

In at least one arrangement, the social networking server may embed haptic data into the generated user interface based on the social networking server computer's relationship evaluation performed in step 345. For example, if the first user specified that a first haptic sensation (e.g., drawing a heart) is to be provided to users of a first group of users (e.g., a “Family” group of users) when they view the status update, and a second haptic sensation (e.g., drawing a smiley face) is to be provided to users of a second group of users (e.g., a “Coworkers” group of users) when they view the status update, then the social networking server computer may embed haptic data into the user interface depending on the group in which the second user is included. For instance, in the example above, if the second user is within the “Family” group of users, then the social networking server computer may embed haptic data into the generated user interface that identifies and/or is configured to cause the second user's computing device to provide a haptic sensation that includes drawing a heart on the second user's hand. Alternatively, if the second user is within the “Co-workers” group of users, for instance, then the social networking server computer may embed haptic data into the generated user interface that identifies and/or is configured to cause the second user's computing device to provide a haptic sensation that includes drawing a smiley face on the second user's hand. In one or more arrangements, these groups may be defined by the first user, e.g., in connection with their social networking account settings and/or privacy preferences.

In step 355, the view update user interface may be provided to the second user. For example, in step 355, the social networking server computer may transmit (e.g., via a TCP/IP data connection) the user interface generated in step 350 to a computing device being used by the second user, such that the second user's computing device may receive the user interface and display the user interface to the second user. As described above, the generated user interface may also include haptic data, which when received by the second user's computing device, may cause the second user's computing device to provide haptic feedback to the second user and/or notify the second user that haptic feedback associated with the status update is available. In at least one arrangement, the haptic feedback provided to the second user may include at least one non-vibratory haptic sensation.

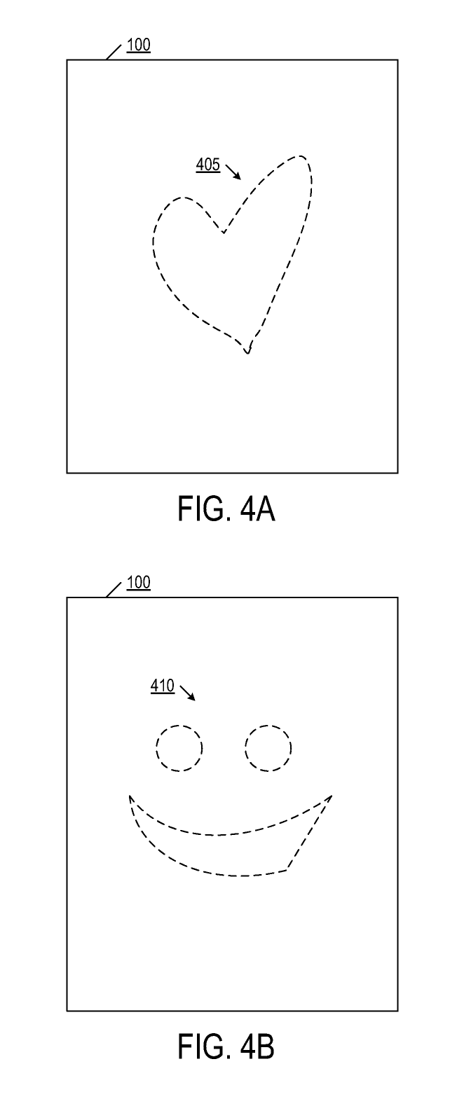

FIG. 4A illustrates an example of haptic feedback that may be provided by a device according to one or more illustrative aspects of the disclosure. For instance, as described above, a shape or other outline may be “drawn” on a user's palm (e.g., by computing device 100 via one or more haptic components) in providing haptic feedback to the user. In one or more configurations, “drawing” such a shape or outline may involve modulating one or more haptic components to create one or more protrusions that form the desired shape or outline. As seen in FIG. 4A, one example of providing this type of haptic feedback may include producing an outline 405 in the shape of a heart on an exterior surface of computing device 100. In this example, if a user were to grasp the computing device 100 in their hand, the user would be able to feel (e.g., using their sense of touch) the protrusion of the outline 405. While an outline of a heart is illustrated and described as an example here, any other shape or outline could be similarly produced and provided as haptic feedback, as desired.

For instance, FIG. 4B illustrates another example of haptic feedback that may be provided by a device according to one or more illustrative aspects of the disclosure. As seen in FIG. 4B, another example of providing haptic feedback may include producing an outline 410 in the shape of a smiley face, e.g., on an exterior surface of computing device 100. In this example, if a user were to grasp the computing device 100 in their hand, the user would be able to feel (e.g., using their sense of touch) the protrusion of the outline 410.

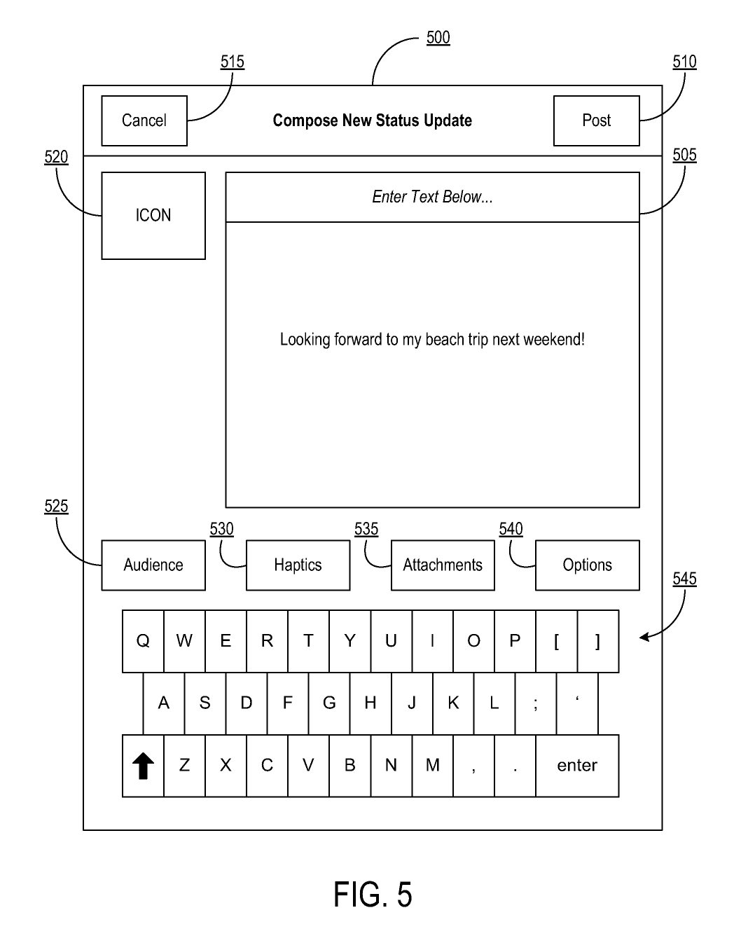

FIGS. 5-8 illustrate example user interfaces for composing status updates that include sensation information according to one or more illustrative aspects of the disclosure. According to one or more aspects, any and/or all of these example user interfaces may be displayed and/or otherwise provided by a user computing device, such as a smart phone, tablet computer, mobile device, laptop computer, desktop computer, or any other type of computing device. In one or more arrangements, the user computing device displaying and/or otherwise providing any and/or all of these example user interfaces may embody one or more aspects of computing device 100, as described above.

Turning now to FIG. 5, an example user interface 500 is illustrated, and the user interface 500 may represent an initial user interface screen displayed in a sequence of user interface screens in composing a status update that includes sensation information (e.g., the sequence of screens illustrated in FIGS. 5-8).

As seen in FIG. 5, user interface 500 may include a text entry region 505 via which a user may enter (and the computing device displaying the user interface 500 may receive) character input to be stored, displayed, and/or shared in connection with the status update being composed. For instance, in the example illustrated in FIG. 5, the user may enter the text “Looking forward to my beach trip next weekend!” to be stored by a social networking server receiving the status update, displayed by the computing device displaying the user interface, and/or shared with one or more other users of the social networking service.

Additionally, user interface 500 may include a post button 510, which may be selectable (e.g., by the user composing the status update and/or otherwise interacting with the computing device providing the user interface 500) to cause the status update being composed to be posted to a server (e.g., the social networking server), and/or a cancel button 515, which may be selectable to cause the status update being composed to be discarded without being posted to the server. User interface 500 may further include one or more icons, such as icon 520, which may represent an icon or other image associated with the user, such as a profile picture associated with the user composing the status update.

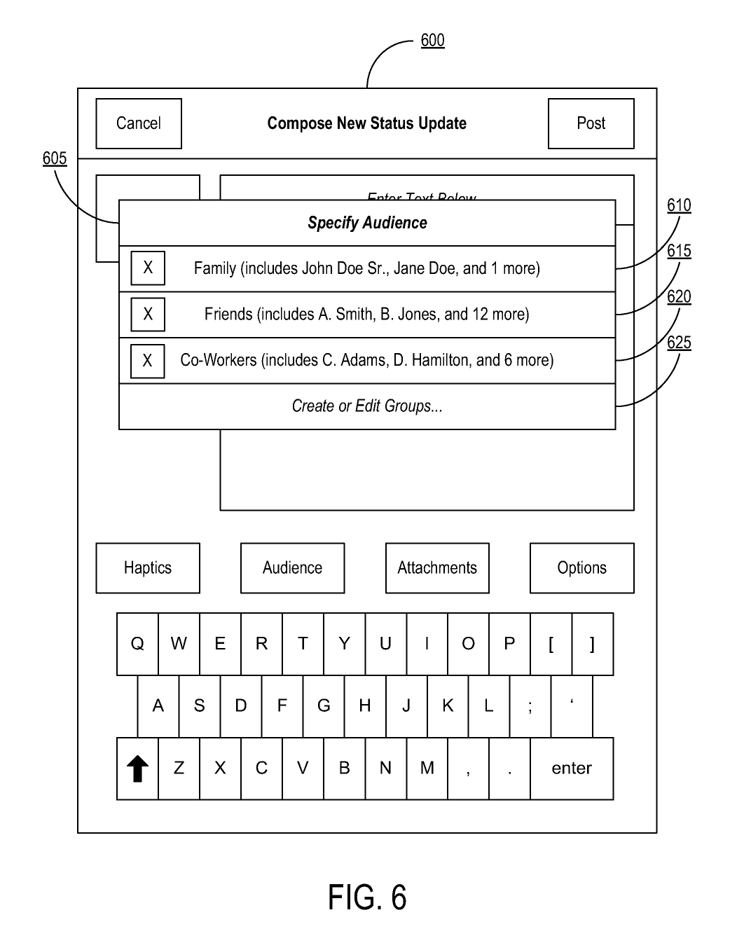

In one or more arrangements, user interface 500 may further include an audience button 525, a haptics button 530, an attachments button 535, and/or an options button 540. In at least one arrangement, the audience button 525 may be selectable to cause an audience selection menu to be displayed (e.g., by the computing device displaying the example user interface 500), via which the user composing the status update can select one or more users and/or one or more groups of users to receive the status update and/or content associated with the status update, such as haptic feedback and/or attachments. An example of such an audience selection menu is illustrated in FIG. 6, which is discussed in greater detail below.

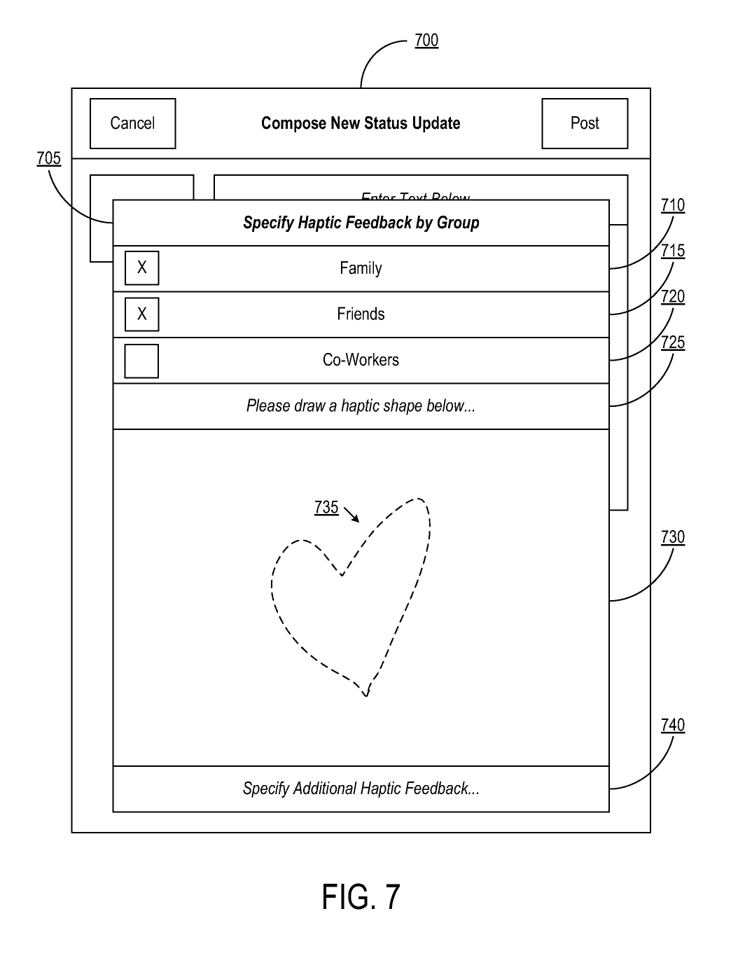

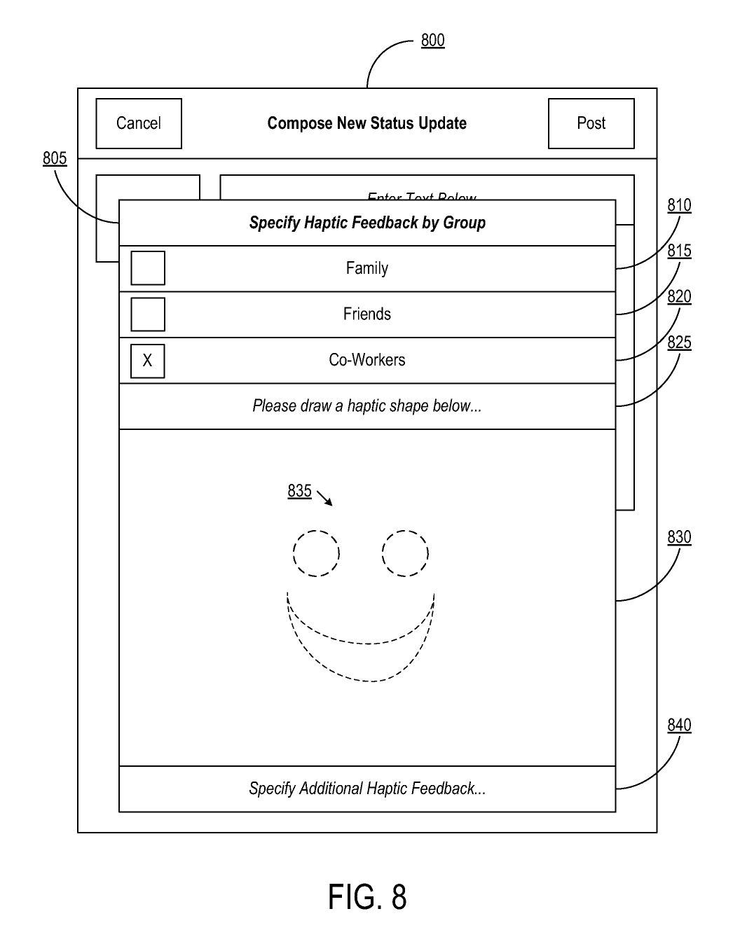

Continuing to refer to FIG. 5, the haptics button 530 of user interface 500 may be selectable to cause a haptic sensation specification menu to be displayed, via which the user composing the status update can select one or more users and/or one or more groups of users to receive one or more particular haptic sensations in connection with the status update. In particular, such a haptic sensation specification menu may allow the user to specify that different recipient users and/or different groups of recipient users are to receive different haptic sensations. For example, the user may be able to specify (and the system may receive and/or provide) different types of haptic feedback to be provided to different recipient users and/or different groups of recipient users. An example of such a haptic sensation specification menu is illustrated in FIGS. 7 and 8, which are discussed in greater detail below.

Continuing to refer to FIG. 5, the attachments button 535 of user interface 500 may be selectable to cause an attachment selection menu to be displayed, via which the user composing the status update can select one or more attachments (e.g., one or more images, one or more sounds, one or more videos, and/or one or more other content items) to be attached to the status update and/or otherwise shared with one or more recipients of the status update. Additionally or alternatively, user interface 500 may include an options button 540, which may be selectable to cause an options menu to be displayed, via which the user composing the status update can create and/or modify one or more settings and/or other preferences associated with the social networking service, for instance. In at least one arrangement, user interface 500 may further include an on-screen keyboard 545, which may include a plurality of buttons that are selectable to facilitate text and/or character entry (e.g., so as to provide input into text entry region 505).

As noted above, based on a user selecting the audience button 525 of user interface 500, for example, an audience selection menu, such as the menu included in the example user interface 600 illustrated in FIG. 6, may be displayed. In particular, as seen in FIG. 6, an audience selection menu 605 may include one or more controls, such as controls 610, 615, and 620, which are selectable to allow a user to specify particular users and/or particular groups of users to be recipients of the status update being composed. Additionally or alternatively, the audience selection menu 605 may include a control 625 that is selectable to allow a user to create new groups of users and/or modify existing groups of users. In one or more arrangements, the different groups of recipient users may be defined by the user composing the status update in connection with the social networking service, and/or may reflect the relationships between the user and the different groups of recipient users as defined in the social networking service. For example, the user may define, in an application and/or interface provided by the social networking service, a first group of users of the social networking service as a “Family” group, and the user may define, in the application and/or interface provided by the social networking service, a second group of users of the social networking service as a “Co-Workers” group, etc. By defining one or more groups of users in this manner, the user composing the status update may more easily and/or more conveniently control what content (e.g., status updates, attachments, haptic sensations, etc.) is shared with other users of the social networking service.

FIG. 7 illustrates an example user interface 700 that includes an example haptic sensation specification menu 705 via which the user may be able to specify different types of haptic feedback to be provided to different recipient users and/or different groups of recipient users. For example, as seen in FIG. 7, the haptic sensation specification menu 705 may include one or more controls, such as controls 710, 715, and 720, which are selectable to allow a user to specify particular users and/or particular groups of users to receive one or more particular haptic sensations.

In one or more arrangements, user interface 700 may further include a selectable prompt 725 that may be configured to prompt a user to draw an outline of a shape, for instance, in haptic input region 730. The shape drawn in the haptic input region 730, such as the example heart 735 illustrated in FIG. 7, may be captured by the computing device providing user interface 700, sent to the social networking server, and/or subsequently provided to one or more users included in the specified groups of users. Thus, in the example illustrated in FIG. 7, one or more users in the “Family” and “Friends” group defined by the user composing the status update may be provided with haptic feedback that includes a protrusion in the shape of heart 735, while one or more other users who are not included in either of these groups, might not be provided with this haptic feedback. As noted above, the prompt 725 may be selectable, and if a user selects the prompt 725, the user may be able to specify that additional and/or different types of haptic feedback are to be provided instead of and/or in addition to the protrusion effect illustrated in the example shown in FIG. 7. For instance, by selecting prompt 725, the user composing the status update may be able to specify that one or more texture sensations, pressure sensations, wetness sensations, adhesion sensations, thermal sensations, and/or vibratory sensations are to be provided instead of and/or in addition to the protrusion effect shown in this example. Where other types of haptic sensations are to be specified and/or otherwise defined in connection with a status update being composed, haptic input region 730 may include and/or otherwise provide other features instead of and/or in addition to those discussed in this example, as may be appropriate for these other types of haptic sensations.

Additionally or alternatively, user interface 700 may further include a selectable prompt 740 that may allow the user composing the status update to specify additional haptic feedback to be provided in connection with the status update being composed. For example, by selecting prompt 740, the user composing the status update may be able to specify one or more haptic sensations to be provided to one or more different users and/or groups of users than those for whom haptic feedback is currently being specified. For instance, based on the user selecting prompt 740, the device providing user interface 700 to the user may display and/or otherwise provide the example user interface illustrated in FIG. 8 to the user.

FIG. 8 illustrates an example user interface 800 that includes an example haptic sensation specification menu 805 that is similar to the haptic sensation specification menu 705 discussed above. For example, like haptic sensation specification menu 705, haptic sensation specification menu 805 may include one or more controls, such as controls 810, 815, and 820, which are selectable to allow a user to specify particular users and/or particular groups of users to receive one or more particular haptic sensations. In addition, haptic sensation specification menu 805 may include selectable prompt 825 (e.g., similar to selectable prompt 725), haptic input region 830 (e.g., similar to haptic input region 730), and/or selectable prompt 840 (e.g., similar to selectable prompt 740).

Unlike the example illustrated in FIG. 7, however, in FIG. 8, the user composing the status update has drawn a different haptic shape (e.g., a smiley face 835) in haptic input region 830 to be provided as haptic feedback to a different group of users (e.g., a different group of users than the groups of users specified in the example illustrated in FIG. 7) when viewing the same status update. For instance, in the example illustrated in FIG. 8, the user composing the status update has specified that a protrusion in the shape of smiley face 835 is to be provided to users included in the “Co-Workers” group as haptic feedback when the status update is viewed by and/or otherwise played back to users in this group, whereas users in the “Family” and “Friends” groups are to be provided with haptic feedback that includes a protrusion in the shape of heart 735 when the same status update is viewed by and/or otherwise played back to users in these groups.

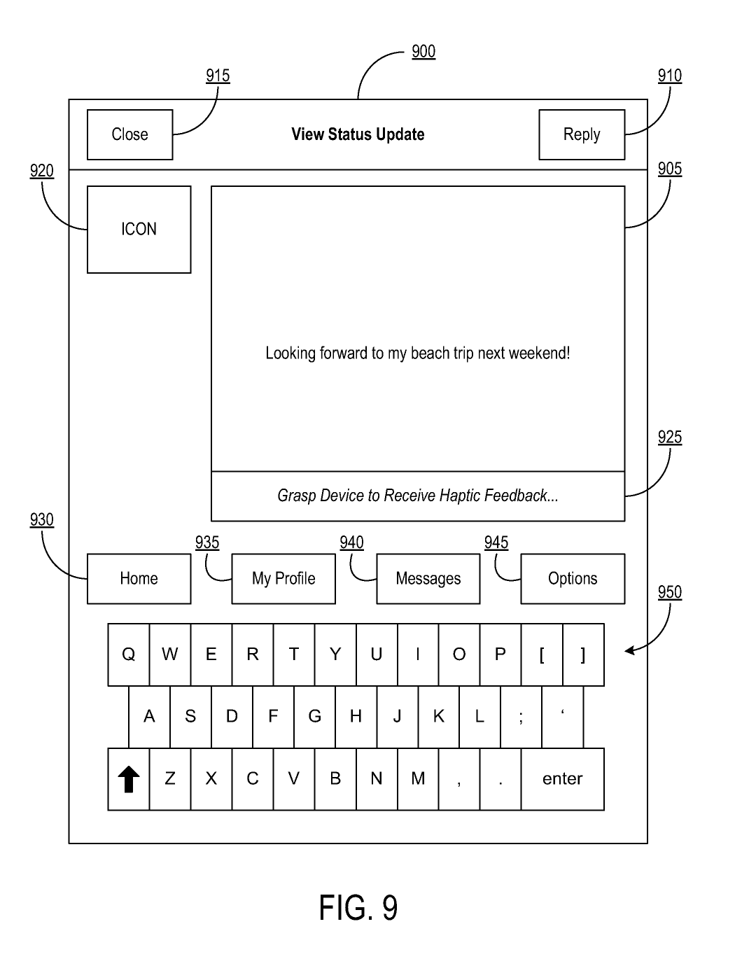

Examples of how this example status update may be displayed, and how the different haptic feedback may be provided to recipients included in the different groups, will now be described with respect to FIGS. 9-11. In particular, FIGS. 9-11 illustrate example user interfaces for displaying status updates that include sensation information according to one or more illustrative aspects of the disclosure.

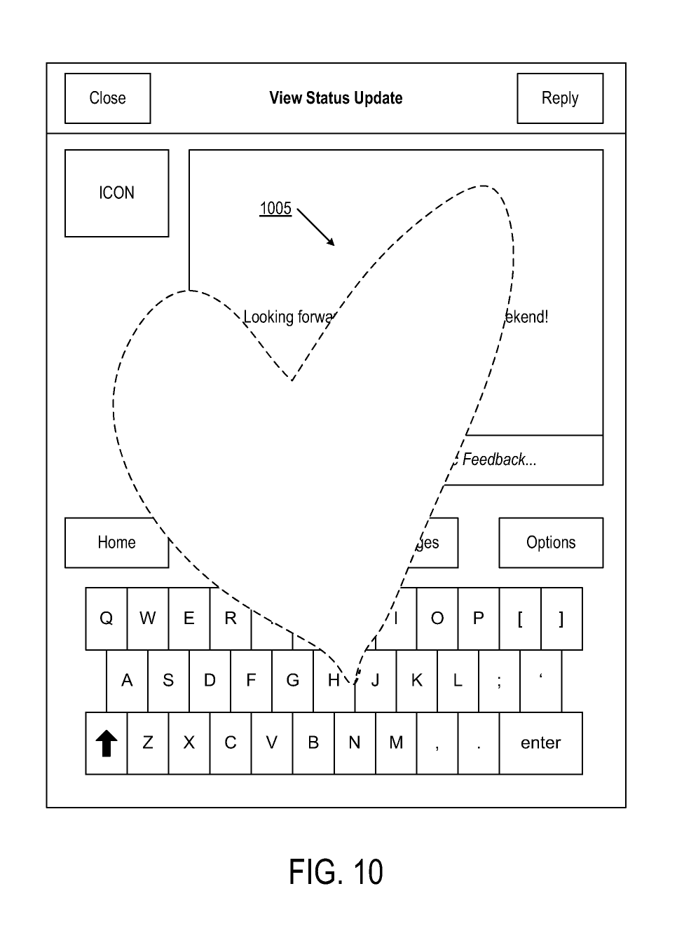

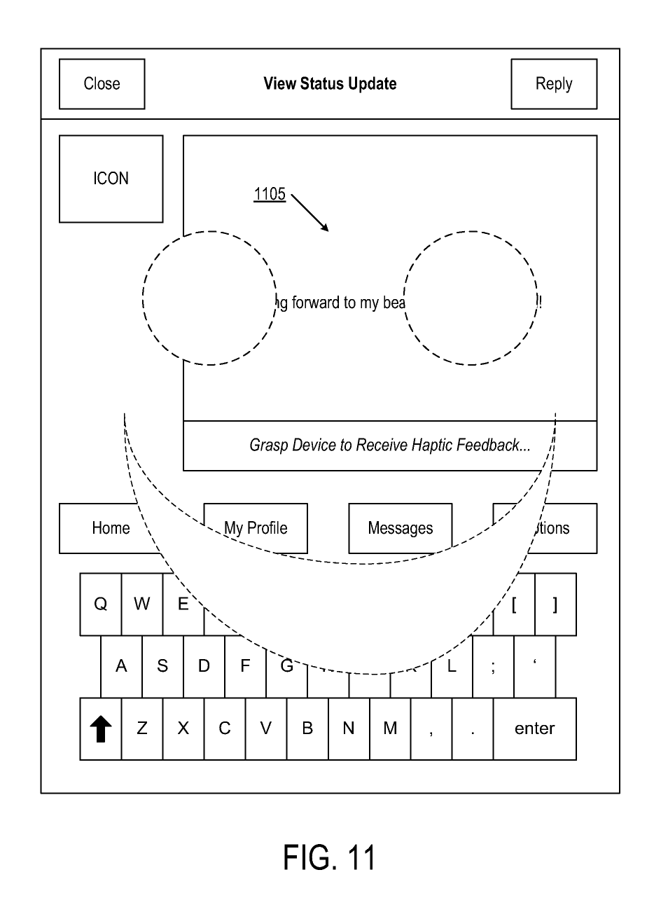

Turning now to FIG. 9, an example user interface 900 is illustrated, and the user interface 900 may represent an initial user interface screen displayed in a sequence of user interface screens in displaying a status update that includes sensation information (e.g., a sequence of screens as illustrated in FIGS. 9 and 10 and/or in FIGS. 9 and 11).

As seen in FIG. 9, user interface 900 may include a text display region 905 in which text and/or character information associated with the status update may be displayed. For instance, in the example illustrated in FIG. 9, the text “Looking forward to my beach trip next weekend” (e.g., as composed by the user who sent the status update in the examples discussed above) may be displayed in the text display region 905. In addition, user interface 900 may include a reply button 910, which may be selectable (e.g., by the user viewing the status update and/or otherwise interacting with the computing device providing the user interface 900) to cause a reply menu to be displayed, via which the user viewing the status update may compose and/or send a reply message to the user who composed the status update. User interface 900 further may include a close button 915, which may be selectable to cause the status update being viewed and/or the window in which the status update is displayed (e.g., user interface 900) to be closed and/or otherwise replaced with another window and/or user interface. In addition, user interface 900 may include one or more icons, such as icon 920, which may represent an icon or other image associated with the user who composed the status update being displayed, such as a profile picture associated with the user who composed the status update.

In one or more arrangements, user interface 900 may further include a prompt 925, which may be configured to prompt a user to perform one or more actions with respect to the computing device providing the user interface 900 in order to “feel” or otherwise receive the haptic feedback provided by the computing device based on the haptic information included in and/or otherwise received with the status update. For example, as seen in the example illustrated in FIG. 9, prompt 925 may prompt the user to grasp the computing device (e.g., the computing device displaying the user interface 900) in order to receive haptic feedback associated with the status update being displayed (e.g., based on the haptic feedback included in the status update and/or based on the user's relationship to the sender of the status update within the social networking service, as discussed above). In some arrangements, the computing device displaying the user interface 900 (e.g., computing device 100) may include one or more grip sensors, and the computing device might be configured to only provide haptic feedback when the computing device determines, based on signals received from the one or more grip sensors, that the user is grasping the computing device. Advantageously, using one or more grip sensors in this way may ensure that a user receives intended haptic feedback that might not otherwise be felt by a user if the computing device is not being grasped by the user, such as a protrusion effect or thermal effect, for example.

In one or more arrangements, user interface 900 may further include a home button 930, a profile button 935, a messages button 940, and/or an options button 945. In at least one arrangement, the home button 930 may be selectable to cause a home screen to be displayed (e.g., by the computing device displaying the user interface 900) that may, for instance, include a plurality of status updates composed by a plurality of users of the social networking service and/or other content. The profile button 935 of user interface 900 may be selectable to cause a profile screen to be displayed, which may, for instance, allow the user (e.g., the user of the computing device displaying the user interface 900) to view and/or edit his or her own profile in the social networking service. Additionally, the messages button 940 of user interface 900 may be selectable to cause a messages menu to be displayed, which may, for instance, allow the user to view and/or compose messages to one or more other users of the social networking service. The options button 945 of user interface 900 may be selectable to cause an options menu to be displayed, via which the user (e.g., the user of the computing device displaying the user interface 900) can create and/or modify one or more settings and/or other preferences associated with the social networking service, for example. In at least one arrangement, user interface 900 may further include an on-screen keyboard 950, which may include a plurality of buttons that are selectable to facilitate text and/or character entry by the user.

As noted above, based on the relationship (e.g., the relationship defined on and/or otherwise in connection with the social networking service) between the user viewing the status update and the user who composed the status update, the user viewing the status update may be provided with different haptic feedback than other users who might view the same status update. Indeed, in the examples discussed above (e.g., with respect to FIGS. 5-8), the user who composed the status update displayed in the example user interface 900 illustrated in FIG. 9 specified that users included in a “Friends” group and users included in a “Family” group are to receive first haptic feedback (e.g., a protrusion in the shape of a heart), while users included in a “Co-workers” group are to receive second haptic feedback (e.g., a protrusion in the shape of a smiley face) different from the first haptic feedback. Thus, FIG. 10 illustrates how a protrusion 1005 in the shape of a heart may be generated and/or otherwise provided as haptic feedback to a user viewing the status update who is included in the “Friends” group or “Family” group defined by the sender of the status update, while FIG. 11 illustrates how a protrusion 1105 in the shape of a smiley face may be generated and/or otherwise provided as haptic feedback to a user viewing the status update who is included in the “Co-workers” group defined by the sender of the status update. In both of these examples, the protrusions provided as haptic feedback may be generated by one or more electronically actuatable haptic components (e.g., haptic components 150 and/or 155), which may, for instance, cause one or more deformations in the surface of a display screen of the computing device (e.g., the display screen of the computing device displaying the user interface 900) in order to produce edges and/or shapes in the form of the desired protrusion(s) when actuated and/or otherwise controlled by the computing device (e.g., by processor 120 of computing device 100).

While the examples illustrated above show how haptic feedback may be provided in association with text and/or character content included in a status update, in other arrangements, a status update might include only image and/or video content, and might not include text content. In such arrangements, haptic feedback may be provided in connection with the image and/or video content included in a status update. Additionally or alternatively, such haptic feedback may be aligned with various features that are part of and/or otherwise included in the image and/or video content. For example, video content associated with a status update may include haptic feedback in the form of a “secret handshake” that is to be felt by only certain users who are members of a particular group (e.g., as defined in the social networking service). As users within the group view and/or otherwise play back the video content, they may be provided with haptic feedback that reproduces the secret handshake.

Having described several example user interfaces that may be displayed and/or otherwise provided (e.g., by a user device, such as computing device 100) in composing and/or displaying status updates that include sensation information, several example methods for composing and/or displaying status updates that include sensation information will now be described.

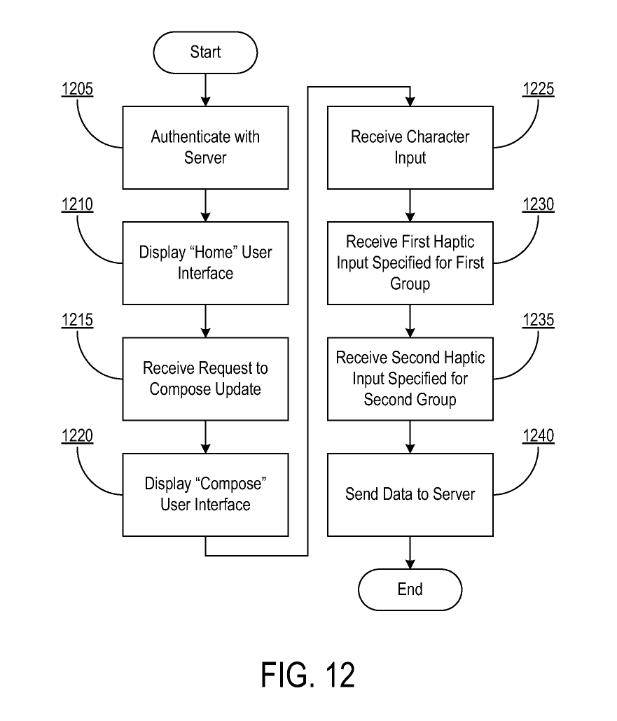

FIG. 12 illustrates an example method of composing a status update that includes sensation information according to one or more illustrative aspects of the disclosure. According to one or more aspects, the example method illustrated in FIG. 12 and/or any and/or all of the method steps thereof may be performed by a user computing device, such as a smart phone, tablet computer, mobile device, laptop computer, desktop computer, or any other type of computing device. In one or more arrangements, the user computing device performing the method and/or the method steps may embody one or more aspects of computing device 100, as described above.

In step 1205, a user computing device (e.g., computing device 100) may authenticate with a server, such as the social networking server computer described above. In at least one arrangement, authenticating with the server may include receiving, by the user computing device, input from a user of the user computing device specifying a username and/or password assigned to the user for use with the social networking service, and subsequently sending, by the user computing device, the received input to the social networking server computer for validation.

Subsequently, in step 1210, the user computing device may display a home screen user interface. In one or more arrangements, displaying a home screen user interface may include receiving a user interface, such as a web page, from the social networking server, and subsequently displaying the received user interface (e.g., to the user of the user computing device). In at least one arrangement, the home screen user interface may include a listing of one or more status updates composed by other users of the social networking service, one or more advertisements, and/or other content and/or controls (e.g., other content associated with the social networking service, such as pictures, music, and/or movies available to the user for viewing and/or playback via the social networking service; and other controls associated with the social networking service, such as one or more preferences menus allowing the user to create and/or edit settings related to privacy, grouping, content playback, etc.).

In step 1215, the user computing device may receive a request to compose a status update. In one or more arrangements, receiving a request to compose a status update may include receiving, by the user computing device, a selection of a control (e.g., a click on a button, a selection from a pull-down menu, etc.) corresponding to a command to compose a new status update.

Thereafter, in step 1220, the user computing device may display a user interface via which the user of the user computing device can compose a new status update. In one or more arrangements, displaying such a user interface may include displaying any and/or all of the example user interfaces illustrated in FIGS. 5-8, as discussed above, and/or displaying one or more additional and/or alternative user interfaces that include one or more controls and/or other elements that allow the user to compose a status update, specify haptic feedback to be associated with the status update, and/or perform other operations involved in composing a status update (e.g., as discussed above).

In step 1225, the user computing device may receive character input, such as one or more characters and/or text entered by the user of the user computing device to be displayed in connection with the status update and/or otherwise shared with other users of the social networking service. In one or more arrangements, the user computing device may receive character input via user interface 500 and/or text entry region 505 thereof, as discussed above.

In step 1230, the user computing device may receive a specification of first haptic input to be provided to users of the social networking service included in a first group of users. In one or more arrangements, the user computing device may receive such a specification of haptic input via haptic sensation specification menu 705, as discussed above. For example, in step 1230, the user computing device may receive user input specifying that first haptic feedback (e.g., a protrusion in the shape of a heart) is to be provided to users included in a “Friends” group of users of the social networking service and a “Family” group of users of the social networking service, where these groups of users are defined by the user composing the status update (e.g., the user of the user computing device).

In step 1235, the user computing device may receive a specification of second haptic input to be provided to users of the social networking service included in a second group of users. In one or more arrangements, the user computing device may receive such a specification of haptic input via haptic sensation specification menu 805, as discussed above. For example, in step 1235, the user computing device may receive user input specifying that second haptic feedback (e.g., a protrusion in the shape of a smiley face) is to be provided to users included in a “Co-workers” group of users of the social networking service, where this group of users is defined by the user composing the status update (e.g., the user of the computing device).

Subsequently, in step 1240, the user computing device may send data to the server. In one or more arrangements, sending data to the server may include sending, by the user computing device, to the social networking server computer, information that includes and/or otherwise corresponds to the received character input, information that includes and/or otherwise corresponds to the received user input specifying the first haptic feedback to be provided to users of the social networking service included in the first group of users, and/or information that includes and/or otherwise corresponds to the received user input specifying the second haptic feedback to be provided to users of the social networking service included in the second group of users. As discussed below, by sending any and/or all of this information to the social networking server computer, one or more recipients of the status update composed by the user of the user computing device may be able to view the status update and/or receive haptic feedback associated with the status update (e.g., corresponding to and/or otherwise based on the haptic feedback specified by the user of the user computing device).

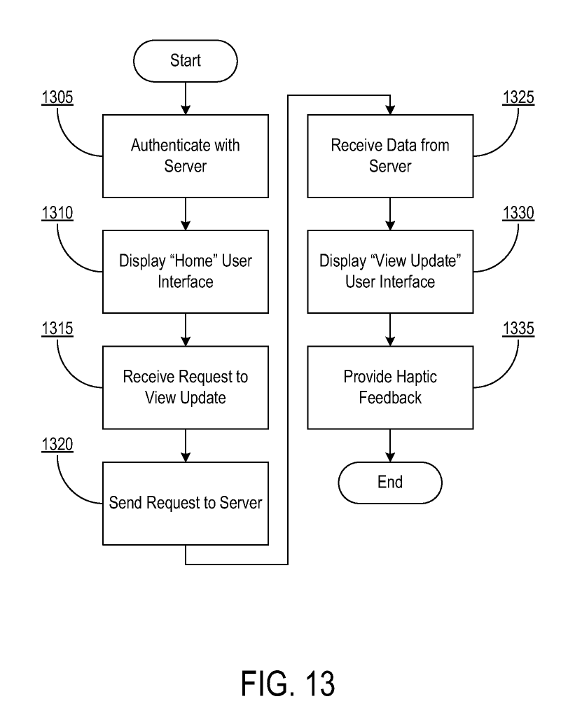

FIG. 13 illustrates an example method of displaying a status update that includes sensation information according to one or more illustrative aspects of the disclosure. According to one or more aspects, the example method illustrated in FIG. 13 and/or any and/or all of the method steps thereof may be performed by a user computing device, such as a smart phone, tablet computer, mobile device, laptop computer, desktop computer, or any other type of computing device. In one or more arrangements, the user computing device performing the method and/or the method steps may embody one or more aspects of the computing device 100, as described above.

In step 1305, a user computing device (e.g., computing device 100) may authenticate with a server, such as the social networking server computer described above. In one example, the user computing device may be used by a user of the social networking service who is a recipient of a status update composed by another user (e.g., such as a user who used his or her own user computing device to compose a status update by performing one or more steps of the example method illustrated in FIG. 12 and discussed above). As above, in one or more arrangements, authenticating with the server in step 1305 of the example method illustrated in FIG. 13 may include receiving, by the user computing device, input from a user of the user computing device specifying a username and/or password assigned to the user for use with the social networking service, and subsequently sending, by the user computing device, the received input to the social networking server computer for validation.

Subsequently, in step 1310, the user computing device may display a home screen user interface. As above, in one or more arrangements displaying a home screen user interface may include receiving a user interface, such as a web page, from the social networking server, and subsequently displaying the received user interface (e.g., to the user of the user computing device). In at least one arrangement, the home screen user interface may include a listing of one or more status updates composed by other users of the social networking service, one or more advertisements, and/or other content and/or controls (e.g., other content associated with the social networking service, such as pictures, music, and/or movies available to the user for viewing and/or playback via the social networking service; and other controls associated with the social networking service, such as one or more preferences menus allowing the user to create and/or edit settings related to privacy, grouping, content playback, etc.).

In step 1315, the user computing device may receive a request to view a status update. In one or more arrangements, receiving a request to view a status update may include receiving, by the user computing device, a selection of a control (e.g., a click on a button, a selection from a pull-down menu, etc.) corresponding to a command to view a particular status update, such as a status update displayed in the listing of one or more status updates included in the home screen.

In step 1320, the user computing device may send a request to the server to obtain the status update and/or additional information stored by the server in connection with the status update. In one or more arrangements, sending a request to the server to obtain the status update may include sending, by the user computing device, a request command to the social networking server that includes an identifier corresponding to the status update, and optionally, an identifier corresponding to the authenticated identity of the user using the user computing device. This may enable the social networking server to determine which status update is being requested by the user computing device, and further may enable the social networking server to determine which, if any, groups the user is included in (e.g., as defined by the sender of the status update). Based on this information, the social networking server computer may determine whether the user has sufficient access privileges to view the status update and/or which, if any, haptic feedback sensations and/or other embedded content should be provided to the user of the user computing device in connection with the status update, as discussed above.

Subsequently, in step 1325, the user computing device may receive data from the server. In one or more arrangements, receiving data from the server may include receiving, by the user computing device, data from the social networking server computer that includes information associated with the status update (e.g., text associated with the status update; embedded images, sounds, and/or videos associated with the status update; etc.) and/or haptic feedback information (e.g., specifying one or more haptic sensations to be provided to the user of the user computing device in connection with the status update).

Thereafter in step 1330, the user computing device may display a user interface via which the user of the user computing device can view the status update and/or receive the haptic feedback associated with the status update. In one or more arrangements, displaying such a user interface may include displaying any and/or all of the example user interfaces illustrated in FIGS. 9-11, as discussed above, and/or displaying one or more additional and/or alternative user interfaces that include one or more controls and/or other elements that allow the user to view the status update, receive haptic feedback associated with the status update, and/or perform other operations involved in viewing the status update (e.g., as discussed above).

In step 1335, the user computing device may provide haptic feedback. In one or more arrangements, providing haptic feedback may include providing haptic feedback based on the one or more haptic sensations specified in the haptic data received from the social networking server in connection with the status update (e.g., in step 1325). For example, the user computing device may provide haptic feedback that includes the one or more haptic sensations specified in the haptic data received from the social networking server in connection with the status update. Additionally or alternatively, the user computing device may provide haptic feedback that includes one or more additional and/or alternative haptic sensations instead of and/or in addition to those specified in the haptic data received from the social networking server in connection with the status update. In at least one arrangement, the user computing device may provide such additional and/or alternative haptic feedback based on user preferences, such as user preferences specifying that certain haptic sensations are to be performed in place of other haptic sensations (e.g., user preferences specifying that thermal sensations are to be produced instead of protrusion sensations, even when a particular status update specifies that protrusion sensations are to be performed in connection with the particular status update).

As also discussed above, haptic feedback is something that may be quite limited on current mobile device platforms. For example, portable devices which include haptic feedback might simply provide vibration. By including new and enhanced forms of haptic feedback, a new dimension in communication may be provided. Haptic feedback may include things that a human can feel (e.g., with their hand, hands, or fingers), such as pressure, texture, pinching, heat, slip, shape, corners, and so on. Aspects of the disclosure relate to incorporating these sensations into social networking applications and/or services. This may greatly enhance the quality of social interactions by adding another dimension of information and making the user experience “sensitive to the touch.”

According to one or more aspects of the disclosure, sensation may be included in a social status update or wall post. A user may choose one or more sensations from a plurality of sensations (e.g., poke; drawing a shape, such as a heart; sending a rhythmic beat; heat; etc.). The sensation may be encoded as metadata in the social update to be played back when another user obtains the social update on a compatible mobile device.

One or more aspects of the disclosure describe and encompass choosing and/or otherwise selecting one or more haptic effects from a plurality of haptic effects (e.g., poke on finger, drawing a heart, heat, etc.) when composing and/or sending a status update for a social network. The chosen and/or selected haptic effect(s) may be encoded with metadata in the social network status update. Subsequently, the status update may be received. The chosen and/or selected haptic effect(s) may then be played back on a receiver when the social network status update is received.

In one or more additional and/or alternative arrangements, user interfaces and/or other features may be provided and/or configured to allow a user to choose a different haptic effect for social contacts in different groups for the same message or status update. For example, a heart effect may be included in the message for members of the user's immediate family, but not for the user's co-workers.

In other additional and/or alternative arrangements, delayed delivery of the one or more sensations may be provided. For instance, the haptic effect(s) might only be replayed when the user would be able to feel such effects, e.g., when the phone is in the user's hand, when the user has a haptic accessory on, or when the phone has a haptic sleeve on.

In still other additional and/or alternative arrangements, user interfaces and/or other features may be provided and/or configured to allow a receiving user to choose to turn on and/or off reception of haptic effects from specific social contacts or groups of social contacts.

In other additional and/or alternative arrangements, user interfaces and/or other features may be provided and/or configured to allow a user to create one or more wall posts that include one or more haptic effects, and/or further allow the one or more haptic effects to be viewable on devices that support the one or more haptic effects. For example, if a wall post includes a texture effect and a particular device (which may, for instance, be accessing and/or display the wall post) does not support the texture effect, a receiver (e.g., a user who may be using the particular device and/or the device itself) might not be notified that a haptic effect is included in the wall post.

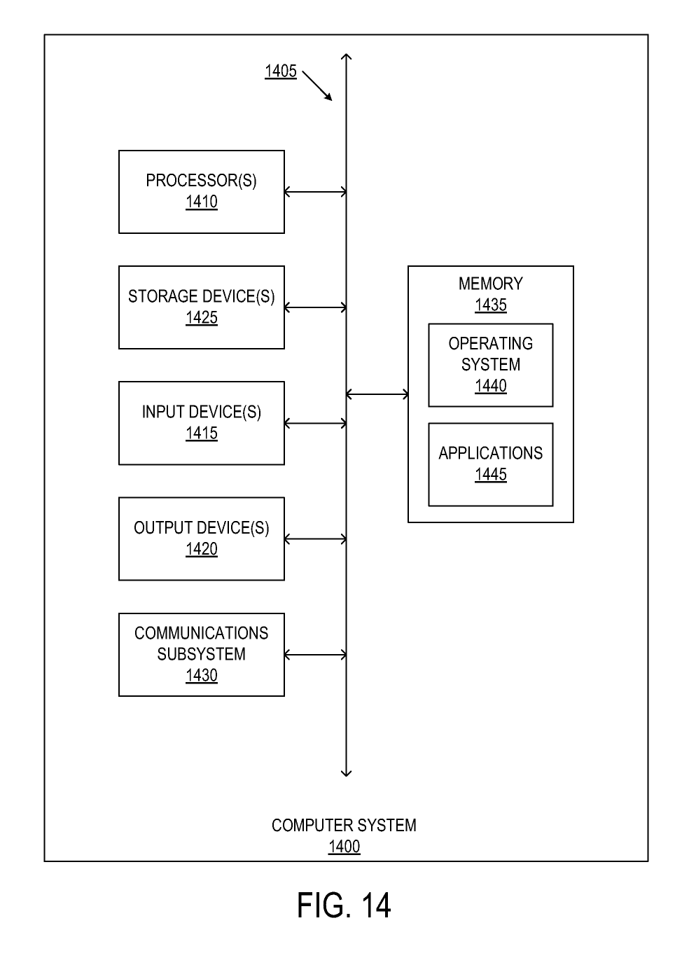

Having described multiple aspects of integrating sensation functionalities into social networking services and/or applications, an example of a computing system in which various aspects of the disclosure may be implemented will now be described with respect to FIG. 14. According to one or more aspects, a computer system as illustrated in FIG. 14 may be incorporated as part of a computing device, which may implement, perform, and/or execute any and/or all of the features, methods, and/or method steps described herein. For example, computer system 1400 may represent some of the components of a hand-held device. A hand-held device may be any computing device with an input sensory unit, such as a camera and/or a display unit. Examples of a hand-held device include but are not limited to video game consoles, tablets, smart phones, and mobile devices. In one embodiment, the computer system 1400 is configured to implement the device 100 described above. In one or more arrangements, computer system 1400 may represent components of and be configured to implement the social networking server computer described above. FIG. 14 provides a schematic illustration of one embodiment of a computer system 1400 that can perform the methods provided by various other embodiments, as described herein, and/or can function as the host computer system, a remote kiosk/terminal, a point-of-sale device, a mobile device, a set-top box, and/or a computer system. FIG. 14 is meant only to provide a generalized illustration of various components, any and/or all of which may be utilized as appropriate. FIG. 14, therefore, broadly illustrates how individual system elements may be implemented in a relatively separated or relatively more integrated manner.

The computer system 1400 is shown comprising hardware elements that can be electrically coupled via a bus 1405 (or may otherwise be in communication, as appropriate). The hardware elements may include one or more processors 1410, including without limitation one or more general-purpose processors and/or one or more special-purpose processors (such as digital signal processing chips, graphics acceleration processors, and/or the like); one or more input devices 1415, which can include without limitation a camera, a mouse, a keyboard and/or the like; and one or more output devices 1420, which can include without limitation a display unit, a printer and/or the like.

The computer system 1400 may further include (and/or be in communication with) one or more non-transitory storage devices 1425, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 1400 might also include a communications subsystem 1430, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 1430 may permit data to be exchanged with a network (such as the network described below, to name one example), other computer systems, and/or any other devices described herein. In many embodiments, the computer system 1400 will further comprise a non-transitory working memory 1435, which can include a RAM or ROM device, as described above.

The computer system 1400 also can comprise software elements, shown as being currently located within the working memory 1435, including an operating system 1440, device drivers, executable libraries, and/or other code, such as one or more application programs 1445, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 2, 3, 12, and/or 13 might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 1400) to perform methods in accordance with the disclosure. For example, some or all of the procedures of the described methods may be performed by the computer system 1400 in response to processor 1410 executing one or more sequences of one or more instructions (which might be incorporated into the operating system 1440 and/or other code, such as an application program 1445) contained in the working memory 1435. Such instructions may be read into the working memory 1435 from another computer-readable medium, such as one or more of the storage device(s) 1425. Merely by way of example, execution of the sequences of instructions contained in the working memory 1435 might cause the processor(s) 1410 to perform one or more procedures of the methods described herein, for example a method described with respect to FIGS. 2, 3, 12, and/or 13.

The terms “machine-readable medium” and “computer-readable medium,” as used herein, refer to any medium that participates in providing data that causes a machine to operate in a specific fashion. In an embodiment implemented using the computer system 1400, various computer-readable media might be involved in providing instructions/code to processor(s) 1410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1425. Volatile media include, without limitation, dynamic memory, such as the working memory 1435. Transmission media include, without limitation, coaxial cables, copper wire and fiber optics, including the wires that comprise the bus 1405, as well as the various components of the communications subsystem 1430 (and/or the media by which the communications subsystem 1430 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1400. These signals, which might be in the form of electromagnetic signals, acoustic signals, optical signals and/or the like, are all examples of carrier waves on which instructions can be encoded, in accordance with various embodiments of the invention.

The communications subsystem 1430 (and/or components thereof) generally will receive the signals, and the bus 1405 then might carry the signals (and/or the data, instructions, etc. carried by the signals) to the working memory 1435, from which the processor(s) 1410 retrieves and executes the instructions. The instructions received by the working memory 1435 may optionally be stored on a non-transitory storage device 1425 either before or after execution by the processor(s) 1410.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method comprising:
receiving, by a computing device, a status update associated with a social networking service, the status update including haptic data; and
causing haptic feedback to be provided, based at least in part on the haptic data and a relationship between at least one user account of the social networking service provided via the computing device and a sender of the status update within the social networking service.

2. The method of claim 1, wherein the haptic data identifies at least one haptic sensation to be provided to a recipient of the status update.

3. The method of claim 1, wherein the haptic data is specified by the sender of the status update.

4. The method of claim 1,
wherein first haptic feedback is provided if the at least one user account is within a first group of users, and
wherein second haptic feedback different from the first haptic feedback is provided if the at least one user account is within a second group of users different from the first group of users.

5. The method of claim 4, wherein the first group of users and the second group of users are defined by the sender of the status update.

6. The method of claim 1, wherein the haptic data is embedded in a header of a webpage that includes the status update.

7. The method of claim 1, wherein the haptic feedback corresponds to an implied message.

8. The method of claim 7, wherein the implied message corresponds to a feature provided by the social networking service.

9. The method of claim 7, wherein the haptic feedback corresponds to a poke feature provided by the social networking service.

10. The method of claim 1,
wherein receiving the status update associated with the social networking service includes:
receiving first information specifying first haptic feedback to be provided to a first group of recipients of the status update; and
receiving second information specifying second haptic feedback to be provided to a second group of recipients of the status update, the second group of recipients of the status update being different from the first group of recipients of the status update, and
wherein causing the haptic feedback to be provided includes:
determining whether the at least one user account is in the first group of recipients of the status update or the second group of recipients of the status update;
in response to determining that the at least one user account is in the first group of recipients of the status update, causing the first haptic feedback to be provided; and
in response to determining that the at least one user account is in the second group of recipients of the status update, causing the second haptic feedback to be provided, the second haptic feedback being different from the first haptic feedback.

11. At least one computer-readable medium having computer-executable instructions stored thereon that, when executed, cause at least one computing device to:
receive a status update associated with a social networking service, the status update including haptic data; and
cause haptic feedback to be provided, based at least in part on the haptic data and a relationship between at least one user account of the social networking service provided via the at least one computing device and a sender of the status update within the social networking service.

12. The at least one computer-readable medium of claim 11, wherein the haptic data identifies at least one haptic sensation to be provided to a recipient of the status update.

13. The at least one computer-readable medium of claim 11, wherein the haptic data is specified by the sender of the status update.

14. The at least one computer-readable medium of claim 11,
wherein first haptic feedback is provided if the at least one user account is within a first group of users, and
wherein second haptic feedback different from the first haptic feedback is provided if the at least one user account is within a second group of users different from the first group of users.

15. The at least one computer-readable medium of claim 14, wherein the first group of users and the second group of users are defined by the sender of the status update.

16. The at least one computer-readable medium of claim 11, wherein the haptic data is embedded in a header of a webpage that includes the status update.

17. The at least one computer-readable medium of claim 11, wherein the haptic feedback corresponds to an implied message.

18. The at least one computer-readable medium of claim 17, wherein the implied message corresponds to a feature provided by the social networking service.

19. The at least one computer-readable medium of claim 11, wherein the haptic data is configured to cause at least a thermal effect to be provided as the haptic feedback.

20. The at least one computer-readable medium of claim 11,
wherein receiving the status update associated with the social networking service includes:
receiving first information specifying first haptic feedback to be provided to a first group of recipients of the status update; and
receiving second information specifying second haptic feedback to be provided to a second group of recipients of the status update, the second group of recipients of the status update being different from the first group of recipients of the status update, and
wherein causing the haptic feedback to be provided includes:
determining whether the at least one user account is in the first group of recipients of the status update or the second group of recipients of the status update;
in response to determining that the at least one user account is in the first group of recipients of the status update, causing the first haptic feedback to be provided; and
in response to determining that the at least one user account is in the second group of recipients of the status update, causing the second haptic feedback to be provided, the second haptic feedback being different from the first haptic feedback.

21. A device comprising:
at least one processor; and
memory storing computer-readable instructions that, when executed by the at least one processor, cause the device to:
receive a status update associated with a social networking service, the status update including haptic data; and
cause haptic feedback to be provided, based at least in part on the haptic data and a relationship between at least one user account of the social networking service provided via the device and a sender of the status update within the social networking service.

22. The device of claim 21, wherein the haptic data identifies at least one haptic sensation to be provided to a recipient of the status update.

23. The device of claim 21, wherein the haptic data is specified by the sender of the status update.

24. The device of claim 21,
wherein first haptic feedback is provided if the at least one user account is within a first group of users, and
wherein second haptic feedback different from the first haptic feedback is provided if the at least one user account is within a second group of users different from the first group of users.

25. The device of claim 24, wherein the first group of users and the second group of users are defined by the sender of the status update.

26. The device of claim 21, wherein the haptic data is embedded in a header of a webpage that includes the status update.

27. The device of claim 21, wherein the haptic feedback corresponds to an implied message.

28. The device of claim 27, wherein the implied message corresponds to a feature provided by the social networking service.

29. The device of claim 21, wherein the haptic data is configured to cause at least a protrusion effect to be provided as the haptic feedback.

30. The device of claim 21,
wherein receiving the status update associated with the social networking service includes:
receiving first information specifying first haptic feedback to be provided to a first group of recipients of the status update; and
receiving second information specifying second haptic feedback to be provided to a second group of recipients of the status update, the second group of recipients of the status update being different from the first group of recipients of the status update, and
wherein causing the haptic feedback to be provided includes:
determining whether the at least one user account is in the first group of recipients of the status update or the second group of recipients of the status update;
in response to determining that the at least one user account is in the first group of recipients of the status update, causing the first haptic feedback to be provided; and
in response to determining that the at least one user account is in the second group of recipients of the status update, causing the second haptic feedback to be provided, the second haptic feedback being different from the first haptic feedback.

31. An apparatus comprising:
means for receiving a status update associated with a social networking service, the status update including haptic data; and
means for causing haptic feedback to be provided, based at least in part on the haptic data and a relationship between at least one user account of the social networking service provided via the apparatus and a sender of the status update within the social networking service.

32. The apparatus of claim 31, wherein the haptic data identifies at least one haptic sensation to be provided to a recipient of the status update.

33. The apparatus of claim 31, wherein the haptic data is specified by the sender of the status update.

34. The apparatus of claim 31,
wherein first haptic feedback is provided if the at least one user account is within a first group of users, and
wherein second haptic feedback different from the first haptic feedback is provided if the at least one user account is within a second group of users different from the first group of users.

35. The apparatus of claim 34, wherein the first group of users and the second group of users are defined by the sender of the status update.

36. The apparatus of claim 31, wherein the haptic data is embedded in a header of a webpage that includes the status update.

37. The apparatus of claim 31, wherein the haptic feedback corresponds to an implied message.

38. The apparatus of claim 37, wherein the implied message corresponds to a feature provided by the social networking service.

39. The apparatus of claim 31, wherein the haptic data is configured to cause at least a non-vibratory haptic sensation to be provided as the haptic feedback.

40. The apparatus of claim 31,
wherein receiving the status update associated with the social networking service includes:
receiving first information specifying first haptic feedback to be provided to a first group of recipients of the status update; and
receiving second information specifying second haptic feedback to be provided to a second group of recipients of the status update, the second group of recipients of the status update being different from the first group of recipients of the status update, and
wherein causing the haptic feedback to be provided includes:
determining whether the at least one user account is in the first group of recipients of the status update or the second group of recipients of the status update;
in response to determining that the at least one user account is in the first group of recipients of the status update, causing the first haptic feedback to be provided; and
in response to determining that the at least one user account is in the second group of recipients of the status update, causing the second haptic feedback to be provided, the second haptic feedback being different from the first haptic feedback.
